(19) United States
(12) Patent Application Publication
(10) Pub. No.: US 2019/0335766 A1
(43) Pub. Date: Nov. 7, 2019

(54) Ink on Dough-Based Articles

(71) Applicant: General Mills, Inc., Minneapolis, MN (US)

(72) Inventors: Jiazhuang LI, Hefei, Anhui (CN); Lance Terrell SANDERS, Edina, MN (US); Wenyi WANG, Blaine, MN (US); Xu ZHANG, Shanghai (CN)

(73) Assignee: General Mills, Inc., Minneapolis, MN (US)

(21) Appl. No.: 16/463,546

(22) PCT Filed: Nov. 23, 2016
(86) PCT No.: PCT/CN2016/106869

§ 371 Date: May 23, 2019

(51) Int. Cl. A21D 13/22; A21D 15/02; A21D 13/28; A21D 13/47; A21D 8/02

(52) U.S. Cl. CPC A21D 13/22; A21D 15/02; A21D 8/02; A21D 13/47; A21D 13/28

(57) ABSTRACT

A dough composition is provided herein that includes an ink on an external surface of the dough composition, and a polymerized alginate layer covering at least a portion of the ink. Also disclosed are dough compositions with printed design on an outer surface. Methods of making a dough composition are also provided.

### BACKGROUND

Dough- and batter-based food articles are generally cooked before consumption. Baking, submerging in hot water, steaming, or frying are common ways to cook dough- and batter-based food articles. Dough- and batter-based food articles are sometimes seen as fun food items that eaten by children or as part of celebrations. Such dough- and batter-based food items, such as cake, filled dumplings, or unfilled dough pieces, can be decorated to enhance their appeal. Cakes, for example, are often frosted with decorative frosting, while filled dumplings and unfilled dough pieces sometimes include brightly colored ingredients or other colorants in the dough and/or filling to provide an appealing color.

### SUMMARY

Embodiments of the invention can have any or all of the herein described features, in any combination that is not mutually exclusive.

Provided herein are decorated dough compositions, such as dumplings, tangyuan, steamed buns (e.g., baozi, mantou), or noodles.

In some embodiments, a decorated dough composition includes a dough component with at least one external surface having an ink thereon, and a polymerized alginate layer covering at least a portion of the ink.

In some embodiments, the polymerized alginate layer can be 0.1 mm to 3 mm thick. In some embodiments, the polymerized alginate layer can be resistant to peeling in boiling water or steam.

In some embodiments, a decorated dough composition includes an ink layer covering a least a portion of a polymerized alginate layer.

In some embodiments, an ink on the external surface of a dough component can be a water soluble ink, a vegetable-based ink, or an extract of natural colorants.

In some embodiments, a decorated dough composition can be uncooked.

In some embodiments, a decorated dough composition can be frozen.

Also provided herein are methods of making decorated dough compositions. In some embodiments, a method of making a decorated dough composition, includes providing an uncooked dough component with an ink on an exposed surface of the uncooked dough component, and applying a polymerized alginate layer over at least a portion of the ink to produce the decorated dough composition.

In some embodiments, an uncooked dough component can include a divalent cation, and the step of applying a polymerized alginate layer can include applying an unpolymerized alginate to the exposed surface of the uncooked dough component, and allowing the divalent cation to react with the unpolymerized alginate to form the polymerized alginate layer.

In some embodiments, an ink can include a divalent cation, and the step of applying a polymerized alginate can include applying an unpolymerized alginate to the exposed surface of the uncooked dough component, and allowing the divalent cation to react with the unpolymerized alginate to form the polymerized alginate layer.

In some embodiments, a step of applying a polymerized alginate layer over at least a portion of an ink on the surface of an uncooked dough component can include applying a divalent cation solution to the exposed surface of the uncooked dough component, followed by applying an unpolymerized alginate solution to the exposed surface of the uncooked dough component.

In some embodiments, an exposed surface is allowed to dry between applying the divalent cation solution and applying the unpolymerized alginate solution.

In some embodiments, an ink comprises an unpolymerized alginate, and the step of applying a polymerized alginate can include applying a divalent cation to the exposed surface of the uncooked dough component, and allowing the divalent cation to react with the unpolymerized alginate to form the polymerized alginate layer.

In some embodiments, a method of making a decorated dough composition can include applying a polymerized alginate layer that is 0.1 mm to 3 mm thick.

In some embodiments, a method of making a decorated dough composition can include applying a polymerized alginate layer that is resistant to peeling in boiling water or steam.

In some embodiments, a method of making a decorated dough composition can include applying an ink layer to cover at least a portion of a polymerized alginate layer.

In some embodiments, a method of making a decorated dough composition can include applying an ink to an exposed surface of an uncooked dough component by machine printing, brushing, stamping, engraving, or burning.

In some embodiments, a method of making a decorated dough composition can include applying an ink to an exposed surface of an uncooked dough component by ink jet printing.

In some embodiments, a method of making a decorated dough composition can include applying an ink that is a water soluble ink or a vegetable-based ink.

In some embodiments, a method of making a decorated dough composition can include applying an ink to an uncooked dough component that is part of a dumpling.

In some embodiments, a method of making a decorated dough composition can include freezing the decorated dough composition following the application of a polymerized alginate layer.

Also provided herein, is an uncooked, decorated dough composition, such as a tangyuan, steamed bun (e.g., baozi or mantou), or dumpling, that includes a dough component having a printed design on an outer surface.

In some embodiments, a printed design can include one or more pattern, one or more logos, one or more letters, numbers, or words, or a combination thereof. In some embodiments, a printed design can have a stroke width that is at least 0.3 mm, or at least 0.8 mm.

In some embodiments, an uncooked, decorated dough composition can be frozen.

Also provided herein is a packaged food product that includes a plurality of any of the uncooked, decorated dough composition described herein.

These and various other features and advantages will be apparent from a reading of the following detailed description.

### DESCRIPTION OF THE DRAWINGS

FIG. 1 shows a picture of tangyuan with ink on the surface that was applied using a printer.

FIG. 2 shows tangyuan that had ink applied to the surface prior to freezing then cooking. Tangyuan that lacks a polymerized alginate layer is on the left and is labeled “Control.” Tangyuan that includes a polymerized alginate layer is on the right and is labeled “Test.”

FIG. 3 shows tangyuan without (Control) or with (Full Dip, Half Dip) a polymerized alginate layer covering at least a portion of ink on a surface of the tangyuan, according to an embodiment.

FIG. 4 shows tangyuan without (Control) or with (Full Dip, Half Dip) a polymerized alginate layer covering at least a portion of ink on a surface of the tangyuan, according to an embodiment.

FIG. 5 shows tangyuan without (Control) or with (Full Dip, Half Dip) a polymerized alginate layer covering at least a portion of ink on a surface of the tangyuan, according to an embodiment.

### DETAILED DESCRIPTION

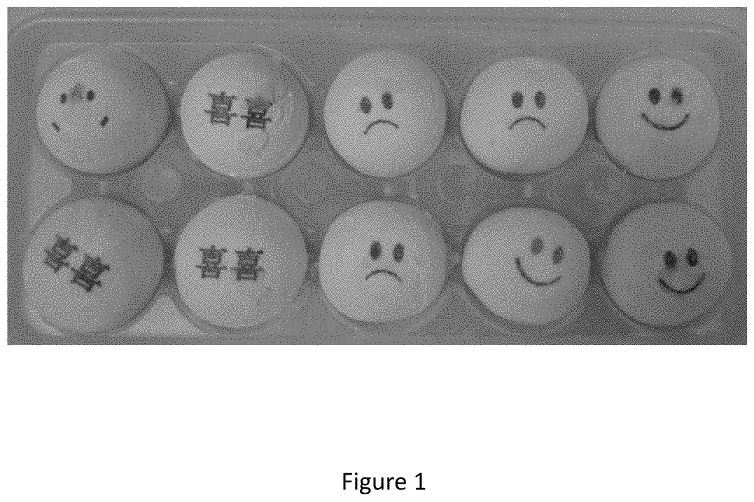

Dough-based food items, such as filled dumplings or unfilled dough pieces, are often part of cultural or regional traditions or celebrations. Tangyuan, for example, is a Chinese food made from a filled or unfilled dough that is cooked and served in hot water as part of celebrations, such as the Lantern Festival, Winter Solstice Festival, and weddings or family reunions. The dough of tangyuan is sometimes colored with colorants, such as dyes or fruit or vegetable juices, to add to the festive appearance of the food. However, tangyuan and other dough products can be difficult to decorate with more complex designs, such as writing (e.g., letters, words, or numbers), symbols, or drawings. While tangyuan occasionally are decorated to resemble faces, mahjong tiles, and cartoon characters, the process is time consuming because it often involves the application, by hand, of different colored dough, food coloring, or chocolate. It has been discovered that complex designs can be efficiently applied to tangyuan, or any other food item having a dough component, using a printer (e.g., ink jet printer, laser printer, or offset printer) to apply edible ink. FIG. 1 shows an example of tangyuan with a printed design (i.e., a design applied using a printer) that was applied using a FUJIFILM Dimatix printer (FUJIFILM Dimatix, Inc., Lebanon, N.H., USA). Application of a printed design on tangyuan provides the ability to decorate many tangyuan in a short period of time, which allows for the efficient manufacture of decorated tangyuan. Printed tangyuan can be made available to a larger number of people without the need for time-consuming preparation of decorated tangyuan in the home.

Further, in some cases, tangyuan and other dough-based foods that are boiled or steamed can have limited decorating options due to the method of cooking, which can damage or remove decorations on the surface. Thus, though some decorations may be acceptable without further protection, such as decorations having a stroke width of at least 0.3 mm (e.g., at least 0.8 mm), it was desired to find a way to preserve decorations, such as the application of an ink to an external surface of a dough composition, through cooking of the dough composition using hot water or steam. A solution for protecting surface decorations is described herein is based on the discovery that application of a polymerized alginate layer over an ink that is on an external surface of a dough can sufficiently protect the ink through a cooking process that involves hot (e.g., boiling) water or steam. Though decorations having a stroke width of at least 0.3 mm (e.g., at least 0.8 mm) can remain readily recognizable after cooking without further protection of the decorations, application of a polymerized alginate layer can improve the quality of decorations having a stroke width of at least 0.3 mm, as well as smaller than 0.3 mm after cooking.

As used herein, the term “stroke width” refers to the width of a solid line used to create a design. Stroke width is not limited herein to designs created by literal strokes of a brush or pen, but also designs created by printing or other techniques.

A method is provided for making a decorated dough composition. A method provided herein includes applying a polymerized alginate layer over at least a portion of an ink on an external surface of an uncooked dough component to produce a decorated dough composition. A dough composition can comprise a dough component that is unfilled (e.g., a noodle, mantou, or unfilled tangyuan), or a filled dough component (e.g., a wonton, baozi, or ravioli). A dough component provided herein can be any leavened or unleavened dough in a form suitable for cooking using hot water and/or steam. Examples of dough compositions include tangyuan (filled or unfilled), ravioli, tortellini, noodles (e.g., rice, buckwheat, or wheat noodles), wontons, momos, British savoury dumplings, pierogi, gnocchi, and the like. Methods of manufacturing dough components suitable for use in a method of making a decorated dough composition provided herein are known. Any known method of making a dough component can be used to provide a dough component for decoration using a method described herein.

An ink can cover all or a portion of an external surface of an uncooked dough component. An ink can comprise any design, including a simple application of one or more color over all or part of an external surface, one or more shapes, one or more outlines, one or more patterns (i.e., repeated decorative design), one or more logos, one or more letters, numbers, or words, or a combination thereof. For example, an ink can comprise a face or a phrase, as shown in FIG. 1.

An ink can be applied to an exterior surface of a dough component using any appropriate method, such as by machine printing (e.g., ink jet printing, laser printing, offset printing), stamping, brushing, engraving (e.g., by laser), or burning (e.g., by use of a hot brand or laser). For example, an ink can be applied to an outer surface of a dough component using an inkjet printer, such as a FUJIFILM Dimatix printer (FUJIFILM Dimatix, Inc., Lebanon, N.H., USA). In another example, an ink can be applied by hand or machine using a brush.

The use of a printer to decorate an outer surface of a dough component is particularly suited for application of an ink to an exterior surface of large numbers of dough components in a short time. A printer has an added benefit of readily being able to change the decoration being applied to dough components. Laser engraving may also provide similar speed and flexibility of a printer. Stamping and burning of decorations onto the surface of a dough component may also provide acceptable speed for manufacture of large numbers of decorated dough components, but may be less flexible for changing design.

An ink can be any food-safe colorant. In some embodiments, an ink suitable for use in a method provided herein can be water soluble or fat soluble. An ink can be, for example, a vegetable-based dye or ink, carbon char from burning or engraving, artificial coloring, or other food-safe colorant suitable for decorating an external surface of an uncooked dough component. A vegetable-based dye or ink can be derived from any appropriate source, such as a fruit or vegetable powder (e.g., carrot powder or spinach powder), a fruit or vegetable juice (e.g., a beet juice or a blueberry juice), a spice (e.g., paprika or saffron), or the like. Examples of suitable vegetable-based dyes or inks include beta-carotene, paprika red, lutein, orange yellow, sorghum red, natural carotene, beet red, chlorophyll extract, and the like. Artificial colors include, for example, FD&C Red #3, FD&C Yellow #5, FD&C Blue #1, FD&C Green #3, and the like. Other colorants include extracts of natural colorants, such as, for example, cochineal extracts, squid ink, and the like. In some embodiments, an ink can include more than one colorant and/or colorant type (e.g., a combination of natural and artificial colorants).

A polymerized alginate layer is applied to cover all or part of an ink on an exterior surface of an uncooked dough component using any appropriate method. Generally, an unpolymerized alginate is applied to all or part of the surface of the uncooked dough component and polymerized by reacting the unpolymerized alginate with a divalent cation suitable for reacting with unpolymerized alginate. As used herein, the term “divalent cation suitable for reacting with unpolymerized alginate”, or simply “divalent cation”, refers to a divalent cation that reacts with an unpolymerized alginate to form a polymerized alginate. Divalent cations suitable for reacting with unpolymerized alginate include, for example, calcium (Ca²⁺), magnesium (Mg²⁺), or iron (Fe²⁺), alone or as part of a salt, that are also suitable for use in a food.

In some embodiments, application of a polymerized alginate layer includes, for example, spraying, brushing, and/or dipping a dough component with an ink on an external surface in a divalent cation solution followed by dipping or spraying an unpolymerized alginate solution on the same surface. The concentration of a divalent cation solution applied to the surface of a dough component can be adjusted to result in a desired rate of polymerization of an alginate later applied, to affect salt concentration and/or flavor of the final dough product, and/or to affect the thickness of the polymerized layer on the surface of the dough component. A divalent cation solution suitable for application to a surface of a dough component can have a concentration ranging from about 0.02 mol/L to about 2 mol/L (e.g., from 0.1 mol/L to about 1 mol/L, or from about 0.3 mol/L to about 0.8 mol/L).

Similarly, the length of time the surface of the dough component is exposed to a divalent cation solution (e.g., by length of time submersed in the solution, or how long the solution is allowed to remain on the surface before applying the unpolymerized alginate solution) can also be adjusted to affect the rate of polymerization, saltiness and/or flavor, and/or the thickness of the polymerized alginate layer. For example, a dough component can be dipped in a divalent cation solution for a length of time from about 0.5 seconds to about 5 minutes (e.g., from about 1 second to about 1 minute, or from about 1 second to about 30 seconds). In some embodiments, a dough component can be stored in a divalent cation solution.

In some embodiments, a dough component that has had a divalent cation applied to its surface can be rinsed (e.g., with water) to remove excess divalent cation or to reduce the concentration of divalent cations on the surface of the dough component.

Following application of a divalent cation solution, an unpolymerized alginate solution can be applied (e.g., by dipping, spraying, or brushing) before or after the dough component dries, to form a decorated dough composition. For example, an unpolymerized alginate solution can be applied while a dough component is still wet following application of a divalent cation solution. In another embodiment, a divalent cation solution is allowed to dry on the surface of a dough component and an unpolymerized alginate solution can be applied at a later time point (e.g., within minutes or after storage of the dough component). As with the concentration and/or exposure time of a divalent cation to a dough component surface, the concentration and/or exposure time of an unpolymerized alginate solution to the dough component surface can be adjusted to affect the rate of polymerization and/or thickness of the polymerized alginate layer. An alginate solution suitable for use in a method provided herein can have a concentration of from about 0.02% to about 5% (e.g., 0.1% to about 2%, or from about 0.5% to about 1%). A dough component can be exposed to an unpolymerized alginate solution for 0.5 seconds to about 5 minutes (e.g., from about 1 second to about 1 minute, or from about 1 second to about 30 seconds).

In some embodiments, a decorated dough composition can be rinsed (e.g., with water) to remove unreacted alginate from the surface of the decorated dough composition.

The thickness of a polymerized alginate layer can be adjusted depending on, for example, the dough component being used, a desired texture, and/or a desired level of protection of the ink that it covers. For example, an ink that is particularly soluble in water or that will be exposed to hot water or steam for a longer period of time might be preferred to be covered by a thicker alginate layer than a fat soluble ink or an ink that will be exposed to hot water or steam for a shorter time. In another example, an alginate layer thickness may be desired to be thinner if expansion of the dough component (or other ingredients) is expected. For example, a dumpling or other filled dough component, can have an alginate layer that is from about 0.1 mm to about 3 mm (e.g., from 0.5 mm to 2.5 mm thick) to allow the dough and/or filling to expand without rupturing the alginate layer or the dough.

Similarly, the amount of surface area of a dough component covered by a polymerized alginate layer can be adjusted depending on, for example, the dough component being used, a desired texture, and/or a desired level of protection of the ink that it covers. For example, all or part of an ink can be covered while leaving at least a portion of the rest of the surface of a dough component uncovered in order to allow for expansion of the dough component, to allow some of the ink to be removed from the surface during cooking, to reduce the amount of alginate used, to reduce the amount of divalent cation used, and/or to result in a desired texture of the final product.

In some embodiments, in addition to, or instead of, applying a divalent cation solution to a surface of a dough component, a divalent cation is included as an ingredient of the dough and/or the ink. In some embodiments, the amount or concentration of divalent cation can be adjusted by further application of a divalent cation solution to increase the amount or concentration of divalent cation on a surface of a dough component, or rinsed (e.g., with water) to reduce the amount or concentration of divalent cation on the surface of the dough component.

In some embodiments, an unpolymerized alginate solution is applied to a dough component surface first, then followed by application of a divalent cation solution. Similarly, an unpolymerized alginate can be included in the dough component ingredients and/or included in an ink, followed by exposure of the unpolymerized alginate to a divalent cation solution. As with initial application of a divalent cation followed by application of an unpolymerized alginate, described above, the concentrations of solutions used and/or included in the dough or ink, or the amount of surface they are applied, can be adjusted to arrive at a polymerized alginate layer with desired characteristics. In addition, concentrations of divalent cation and/or unpolymerized alginate can be adjusted by further application of the appropriate solution and/or rinsing, as described above.

In some embodiments, an ink can be between application of a divalent cation solution or unpolymerized alginate solution but before polymerization of the alginate layer. For example, a dough component can have a divalent cation solution applied to its surface followed by an application of an ink, and finally application of an unpolymerized alginate solution, to form a decorated dough composition.

In some embodiments, multiple layers of polymerized alginate can be applied to a surface of a dough component by alternately applying a divalent cation solution and an unpolymerized alginate solution at least one additional time following the application of a first polymerized alginate layer.

A polymerized alginate layer covering all or a portion of an ink on a surface of a dough component is preferably resistant to peeling in hot water or steam during normal cooking of the dough component. The term “resistant to peeling” indicates that, following normal cooking in hot (e.g., boiling) water or steam, the polymerized alginate layer remains substantially intact and attached to the dough component (e.g., covering at least 80%, or at least 90%, of the surface area following normal cooking in hot water or steam as compared to prior to cooking). In some embodiments, a polymerized alginate layer can be made resistant to peeling by ensuring that edges of the layer are either strongly adhered to the surface of a dough component or are not directly exposed to steam or hot water during cooking (e.g., by folding the edges into the dough). In some embodiments, a polymerized layer can be made resistant to peeling by covering the entire surface of a dough component with the layer, such that the amount of edge of the layer is minimal or eliminated.

In some embodiments, the amount of surface area covered by a polymerized alginate layer can be adjusted to cover the desired amount of ink even if some of the polymerized alginate layer peels off during cooking. For example, a polymerized alginate layer can be applied such that it covers at least 20% more (e.g., at least 30% more) surface area of a dough component as is necessary to cover the desired amount of ink on the surface of the dough component. This can allow the alginate to be not resistant to peeling while still achieving the desired effect of protecting ink on a surface of a dough component during cooking.

In some embodiments, one or more additional ink can be applied on top of a polymerized alginate layer. The additional ink may or may not be further covered with an additional polymerized alginate layer, depending on the desired effect. For example, an additional ink may be left uncovered by an additional polymerized alginate layer if the desired effect is that the additional ink is washed away during cooking. Such an effect may be used as a fun way to reveal a design during cooking. That is, an additional ink can obscure an ink on the surface of a dough component, where the ink on the dough surface is protected by a polymerized alginate layer, and upon cooking the additional ink is removed to reveal the ink on the surface.

In some embodiments, a dough component can be further combined with additional food ingredients prior to cooking. For example, a dough component can be combined with a sauce or a broth prior to cooking.

In some embodiments, a dough component can be frozen or refrigerated following application of a polymerized alginate layer. In some embodiments, a dough component can be packaged for sale. In some embodiments, a plurality of dough components can be packaged in a single package.

Methods provided herein can be adapted to any desired manufacturing method. For example, steps in a provided method of decorating tangyuan can be performed on a system that includes one or more of a conveyor, an automatic cutting and rounding machine, an automatic forming machine, a sprayer, a liquid bath, and/or a blast freezer.

Described below are examples of methods and compositions provided herein.

### EXAMPLES

### Example 1

Tangyuan samples were prepared using a dough formula made from combining waxy rice flour (about 55% by weight) with water (about 45% by weight) in a mixer until fully incorporated. A filling was prepared by combining black sesame powder (about 45% by weight), sugar (about 35% by weight), and butter (about 20% by weight) in a mixer until fully incorporated. For each tangyuan, about 12 g of the dough was rolled out to make a flat sheet. About 8 grams of filling was placed on the center of the flat sheet of dough, and the dough sheet was wrapped around the filling to produce a filled dough ball.

Each tangyuan was marked with marked with red food coloring with a brush and allowed to dry. Control samples were frozen in a blast freezer for 20 minutes at −10° F. Test samples were dipped in a 5% calcium chloride solution for 3 seconds, and allowed to dry, then were dipped in a 0.8% sodium alginate solution for 3 seconds, and allowed to dry. Test samples were frozen in a blast freezer for 20 minutes at −10° F.

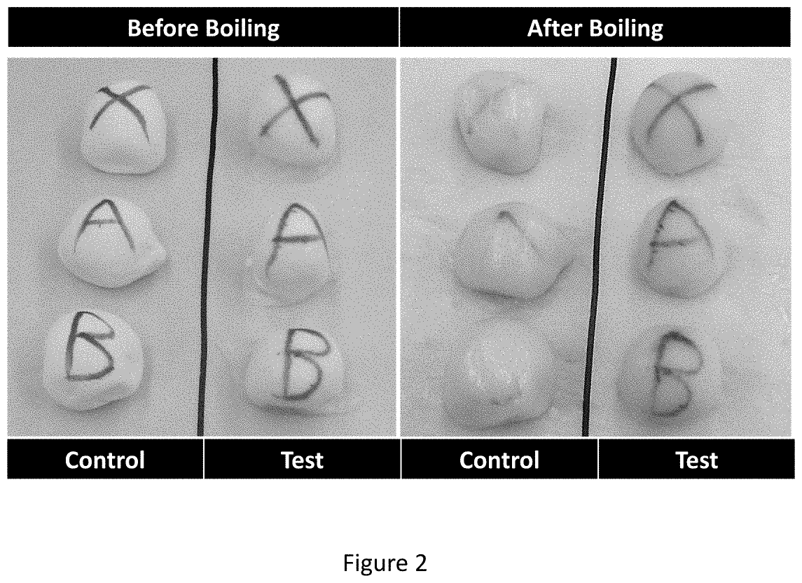

Control samples and test samples were cooked from frozen in boiling water for 7 minutes. FIG. 2 shows the results. Tangyuan that had an alginate layer applied prior to freezing retained the red food coloring to a greater degree than control tangyuan.

### Example 2

Tangyuan were prepared using the dough, filling, and wrapping method described in Example 1. Control samples were prepared in the same manner described for the control samples in Example 1.

Test samples were divided into 3 groups: Test 1 (Full Dip and Half Dip), Test 2 (Full Dip and Half Dip), and Test 3 (Full dip and Half Dip). For Test 1 Full Dip samples, tangyuan were fully submerged in a 5% calcium chloride solution for 3 seconds, dried, and then food coloring was applied with a paint brush. After the food coloring was allowed to dry, the control tangyuan samples were fully submerged in a 0.8% alginate solution for 3 seconds, dried, then frozen in a blast freezer for 20 minutes at −10° F. For Test 1 Half Dip samples, tangyuan were dipped in a 5% calcium chloride solution, such that only about half of the tangyuan was submerged, for 3 seconds. Once the calcium chloride was dried, food coloring was applied to the portion of the tangyuan that was dipped in calcium chloride, and allowed to dry. The tangyuan Test 1 Half Dip samples were then dipped in a 0.8% alginate solution, such that the same half with the calcium chloride and food coloring was submerged, for 3 seconds, then dried and frozen.

For Test 2 samples, tangyuan were painted with food color that included 0.8% sodium alginate, and then allowed to dry. Both the Full Dip and Half Dip Test 2 samples were dipped in a 5% calcium chloride solution for 5 seconds, dried, and frozen. For Full Dip Test 2 samples, the tangyuan were fully submerged in the calcium chloride solution, while for the Half Dip Test 2 samples, the half that included the painted surface was submerged in the calcium chloride solution.

For Test 3 samples, tangyuan were painted with food color that included 5% calcium chloride, and then allowed to dry. Both the Full Dip and Half Dip Test 3 samples were dipped in a 0.8% sodium alginate solution for 3 seconds. For Full Dip Test 3 samples, the tangyuan were fully submerged in the sodium alginate solution, while for the Half Dip Test 3 samples, the half that included the painted surface was submerged in the sodium alginate solution.

For all of the Control, Test 1, Test 2, and Test 3 samples, the concentration of the coloring agent in the food coloring remained constant.

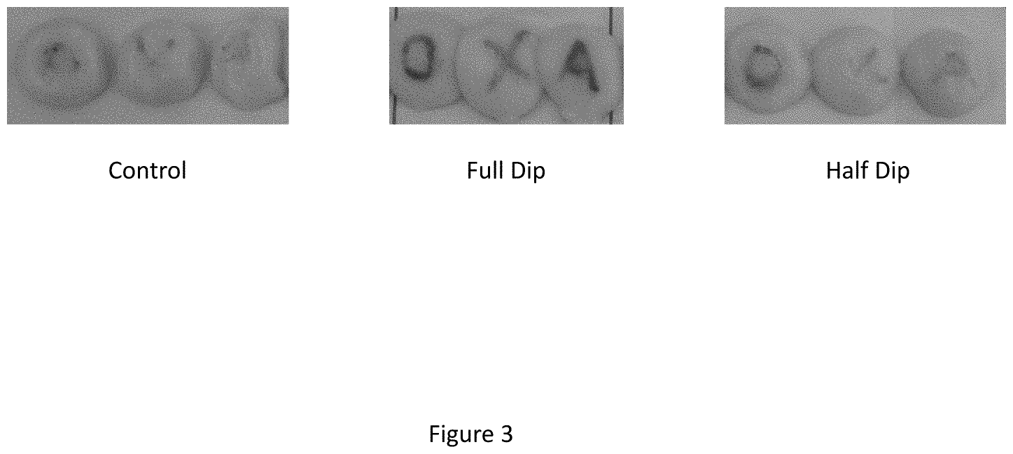

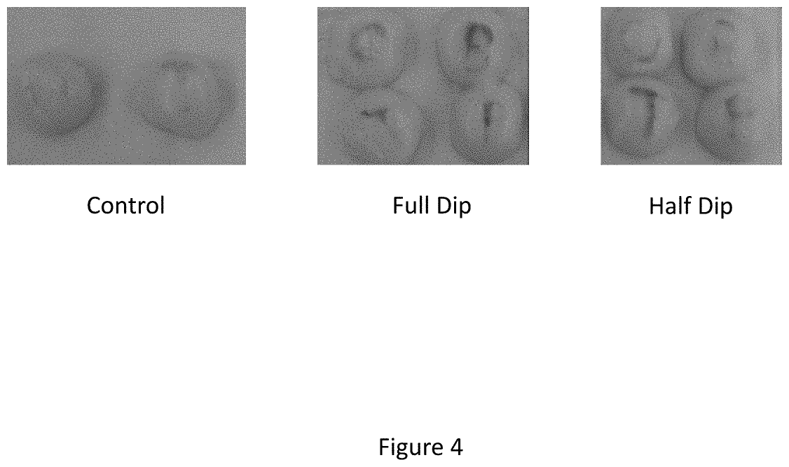

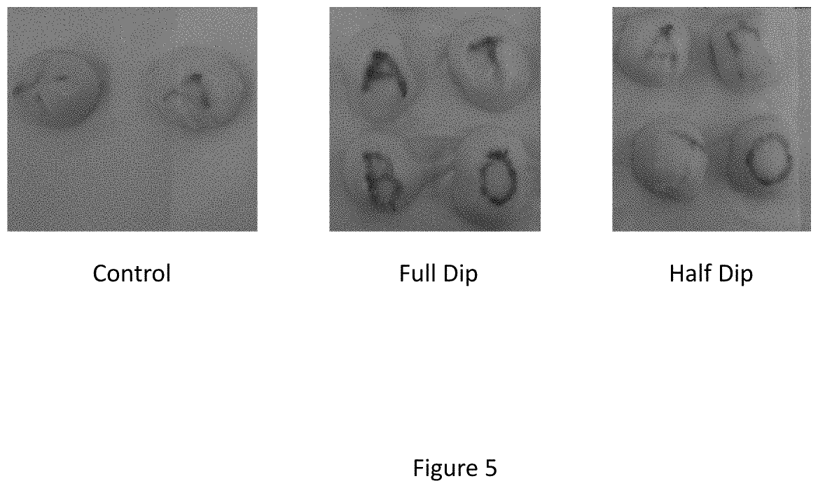

Control samples and test samples were cooked from frozen in boiling water for 7 minutes. FIG. 3 shows the results for Test 1. FIG. 4 shows the results for Test 2. FIG. 5 shows the results for Test 3. Tangyuan that were fully dipped prior to freezing retained the red food coloring to a greater degree than control tangyuan. However, Half Dip samples also showed a reasonable degree of ink protection, especially if the alginate layer remained adhered to the dough. In addition, samples that contained either sodium alginate or calcium chloride in the ink also showed protection of the ink, with the calcium chloride in the ink providing better results.

Unless otherwise indicated, all numbers expressing feature sizes, amounts, and physical properties used in the specification and claims are to be understood as being modified in all instances by the term “about.” The term “about” indicates that the identified number varies by no more than 10% (e.g., no more than 5% or no more than 1%). For example, an alginate layer that is from 0.1 mm to 3 mm thick may vary from 0.09 mm to 3.3 mm, if the variation is no more than 10%.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A decorated dough composition, comprising a dough component with at least one external surface having an ink thereon, and a polymerized alginate layer covering at least a portion of the ink.

2. The decorated dough composition of claim 1, wherein the dough composition is a dumpling, tangyuan, baozi, mantou, or noodle.

3. The decorated dough composition of claim 1, wherein the dough composition is uncooked.

4. The dough composition of claim 1, wherein the polymerized alginate layer is 0.1 mm to 3 mm thick.

5. The decorated dough composition of claim 1, wherein the polymerized alginate layer is resistant to peeling in boiling water or steam.

6. The decorated dough composition of claim 1, wherein the decorated dough composition further comprises an ink layer covering a least a portion of the polymerized alginate layer.

7. The decorated dough composition of claim 6, wherein the ink on the external surface of the dough component is a water soluble ink or a vegetable-based ink.

8. The decorated dough composition of claim 1, wherein the decorated dough composition is frozen.

9. A method of making a decorated dough composition, comprising:
a. providing an uncooked dough component with an ink on an exposed surface of the uncooked dough component, and
b. applying a polymerized alginate layer over at least a portion of the ink to produce the decorated dough composition.

10. The method of claim 9, wherein the uncooked dough component comprises a divalent cation, and step b. comprises applying an unpolymerized alginate to the exposed surface of the uncooked dough component, and allowing the divalent cation to react with the unpolymerized alginate to form the polymerized alginate layer.

11. The method of claim 9, wherein the ink comprises a divalent cation, and step b. comprises applying an unpolymerized alginate to the exposed surface of the uncooked dough component, and allowing the divalent cation to react with the unpolymerized alginate to form the polymerized alginate layer.

12. The method of claim 9, wherein step b. includes the steps of:
c. applying a divalent cation solution to the exposed surface of the uncooked dough component, followed by
d. applying an unpolymerized alginate solution to the exposed surface of the uncooked dough component.

13. The method of claim 12, wherein the exposed surface is allowed to dry between applying the divalent cation solution and applying the unpolymerized alginate solution.

14. The method of claim 9, wherein the ink comprises an unpolymerized alginate, and step b. comprises applying a divalent cation to the exposed surface of the uncooked dough component, and allowing the divalent cation to react with the unpolymerized alginate to form the polymerized alginate layer.

15. The method of claim 9, wherein the polymerized alginate layer is 0.1 mm to 3 mm thick.

16. The method of claim 9, wherein the polymerized alginate layer is resistant to peeling in boiling water or steam.

17. The method of claim 9, further comprising applying an ink layer to cover at least a portion of the polymerized alginate layer.

18. The method of claim 9, wherein the ink is applied to the exposed surface of the uncooked dough component by machine printing, brushing, stamping, engraving, or burning.

19. The method of claim 18, wherein the ink is applied to the exposed surface by ink jet printing.

20. The method claim 9, wherein the ink on the exposed surface of the uncooked dough component is a water soluble ink or a vegetable-based ink.

21. The method of claim 9, wherein the uncooked dough component is part of a dumpling.

22. The method of claim 9, further comprising freezing the decorated dough composition following step b.

23-29. (canceled)
